(19) United States
(12) Patent Application Publication
(10) Pub. No.: US 2015/0249868 A1
(43) Pub. Date: Sep. 3, 2015

(54) INTERNET PROTOCOL TELEVISION TIERED SERVICE DELIVERY OVER WI-FI NETWORKS

(71) Applicant: Alcatel-Lucent USA Inc., Murray Hill, NJ (US)

(72) Inventors: Shengqiang Wang, Cary, NC (US); Ranjan Sharma, New Albany, OH (US)

(73) Assignee: Alcatel-Lucent USA Inc., Murray Hill, NJ (US)

(21) Appl. No.: 14/193,215

(22) Filed: Feb. 28, 2014

(51) Int. Cl. H04N 21/647; H04N 21/643; H04N 21/438; H04N 21/6405; H04N 21/258; H04N 21/437; H04N 21/239; H04N 21/61

(52) U.S. Cl. CPC H04N 21/64753; H04N 21/2396; H04N 21/64322; H04N 21/6125; H04N 21/6405; H04N 21/25816; H04N 21/6175; H04N 21/437; H04N 21/438

(57) ABSTRACT

Systems and methods that provide different levels of Internet Protocol Television (IPTV) services on Wi-Fi networks utilizing concurrent multicast streams. One embodiment comprises a Wi-Fi Access Point (AP) that identifies IPTV channel subscription information for users of Wi-Fi client devices. The AP utilizes multiple Group Temporal Keys (GTKs) to concurrently encrypt and multicast different IPTV channels, and provides the appropriate GTKs to the client devices based on the subscription information to allow different users of the Wi-Fi client devices to receive different packages of IPTV channels.

### CROSS-REFERENCE TO RELATED APPLICATIONS

The subject matter of this application is related to that of U.S. patent application Ser. No. ______ (attorney docket 814030), filed on Feb. 28, 2014 and incorporated herein by reference in its entirety.

### FIELD OF THE INVENTION

The invention is related to the field of communication systems and, in particular, to IPTV systems for Wi-Fi networks.

### BACKGROUND

Internet-Protocol Television (IPTV) is a service through which television and other video content is delivered to an end user over a packet-switched network, such as the Internet. An IPTV subscriber connects to an IPTV network in a similar way that a cable subscriber connects to a cable network. The IPTV subscriber receives a set-top box from the IPTV provider, and the set-top box connects to the IPTV backend over a packet-switched network. The connection between the IPTV backend and the set-top box, for example, may be a Digital Subscriber Line (DSL), fiber, etc. One or more servers within the IPTV backend then provide the television content to the set-top box for viewing over the subscriber's television or other suitable display. The IPTV subscriber can view a programming guide displayed by the set-top box, and select programs or videos to watch.

The availability of Wi-Fi access points is increasing rapidly. Thus, it would be advantageous to allow Wi-Fi client devices to access the IPTV network. However, Wi-Fi provides limited multicast support which precludes the implementation of subscriber-segmented IPTV channel packages.

### SUMMARY

Embodiments described herein provide different levels of IPTV services on Wi-Fi networks utilizing multicast streams encrypted with different Group Temporal Keys (GTKs). When a client device connects to a Wi-Fi Access Point (AP), the client device can receive IPTV channels via multicast streams from the AP. The client device can receive IPTV channels that are different than other client devices on the AP using different GTKs, which allows the IPTV provider to support subscription-based channel packages over Wi-Fi. For instance, one client may subscribe and receive multicast streams for HBO and Showtime encrypted with a one GTK from an AP, while another client may subscribe and receive multicast streams from HBO and Stars encrypted with a different GTK from the same AP.

One embodiment comprises a Wi-Fi access point (AP). The AP includes an Internet Protocol Television (IPTV) controller and a radio interface. The radio interface is configured to receive a first join request from a first Wi-Fi client device for a first IPTV channel. The IPTV controller is configured to identify IPTV channel subscription information for a user of the first client device responsive to the first join request, and to determine if the user of the first client device subscribes to the first IPTV channel based on the subscription information. The radio interface is further configured to transmit a first Group Temporal Key (GTK) to the first client device responsive to a determination that the user of the first client device subscribes to the first IPTV channel, to encrypt the first IPTV channel utilizing the first GTK, and to multicast the first encrypted IPTV channel. The radio interface is further configured to receive a second join request from a second Wi-Fi client device for a second IPTV channel. The IPTV controller is further configured to identify IPTV channel subscription information for a user of the second client device responsive to the second join request, and to determine if the user of the second client device subscribes to the second IPTV channel based on the subscription information. The radio interface is further configured to transmit a second GTK to the second client device responsive to a determination that the user of the second client device subscribes to the second IPTV channel, to encrypt the second IPTV channel utilizing the second GTK, and to multicast the second encrypted IPTV channel concurrently with the first encrypted IPTV channel.

Another embodiment comprises a method of providing different levels of IPTV services on Wi-Fi networks utilizing multicast streams encrypted with different GTKs. The method comprises receiving, by a Wi-Fi access point, a first join request from a first Wi-Fi client device for a first IPTV channel, and identifying, by the Wi-Fi access point, IPTV channel subscription information for a user of the first client device responsive to the first join request. The method further comprises determining, by the Wi-Fi access point, if the user of the first client device subscribes to the first IPTV channel based on the subscription information, and transmitting, by the Wi-Fi access point, a first Group Temporal Key (GTK) to the first client device responsive to a determination that the user of the first client device subscribes to the first IPTV channel. The method further comprises encrypting, by the Wi-Fi access point, the first IPTV channel utilizing the first GTK, and multicasting, by the Wi-Fi access point, the first encrypted IPTV channel. The method further comprises receiving, by the Wi-Fi access point, a second join request from a second Wi-Fi client device for a second IPTV channel, and identifying, by the Wi-Fi access point, IPTV channel subscription information for a user of the second client device responsive to the second join request. The method further comprises determining, by the Wi-Fi access point, if the user of the second client device subscribes to the second IPTV channel based on the subscription information, and transmitting, by the Wi-Fi access point, a second GTK to the second client device responsive to a determination that the user of the second client device subscribes to the second IPTV channel. The method further comprises encrypting, by the Wi-Fi access point, the second IPTV channel utilizing the second GTK, and multicasting, by the Wi-Fi access point, the second encrypted IPTV channel concurrently with the first encrypted IPTV channel.

Another embodiment comprises a Wi-Fi client device that includes a radio interface and a controller. The radio interface is configured to communicate with a Wi-Fi Access Point (AP). The controller is configured to receive Internet Protocol Television IPTV subscription information from a user, and to receive a selection of a first IPTV channel from the user. The radio interface is further configured to transmit the subscription information to the AP, and to transmit a first join request to the AP for a first IPTV channel. The radio interface is further configured to receive a first Group Temporal Key (GTK) from the AP responsive to the first join request, and to receive an encrypted multicast of the first IPTV channel from the AP. The controller is further configured to receive a selection of a second IPTV channel from the user. The radio interface is further configured to transmit a second join request to the AP for the second IPTV channel, to receive a second GTK from the AP responsive to the second join request, and to receive an encrypted multicast of the second IPTV channel from the AP concurrently with the encrypted multicast of the first IPTV channel. The radio interface is further configured to decrypt the first IPTV channel utilizing the first GTK, and to decrypt the second IPTV channel utilizing the second GTK.

Other exemplary embodiments may be described below.

### DESCRIPTION OF THE DRAWINGS

Some embodiments of the invention are now described, by way of example only, and with reference to the accompanying drawings. The same reference number represents the same element or the same type of element on all drawings.

FIG. 1 illustrates a communication network for providing IPTV services over Wi-Fi in an exemplary embodiment.

FIG. 2 is a flow chart illustrating a method of providing different levels of IPTV services on Wi-Fi networks utilizing multicast streams encrypted with different GTKs in an exemplary embodiment.

FIG. 3 illustrates another communication network for providing IPTV services over Wi-Fi in an exemplary embodiment.

FIG. 4 is a flow chart illustrating a method of adding an IPTV subscriber in an exemplary embodiment.

FIG. 5 is a flow chart illustrating a method of deleting an IPTV subscriber in an exemplary embodiment.

FIG. 6 is a flow chart illustrating a method of adding an IPTV subscriber to an IPTV channel in an exemplary embodiment.

FIG. 7 is a flow chart illustrating a method of removing an IPTV subscriber from an IPTV channel in an exemplary embodiment.

FIG. 8 is a flow chart illustrating another method of removing an IPTV subscriber from an IPTV channel in an exemplary embodiment.

### DESCRIPTION OF EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

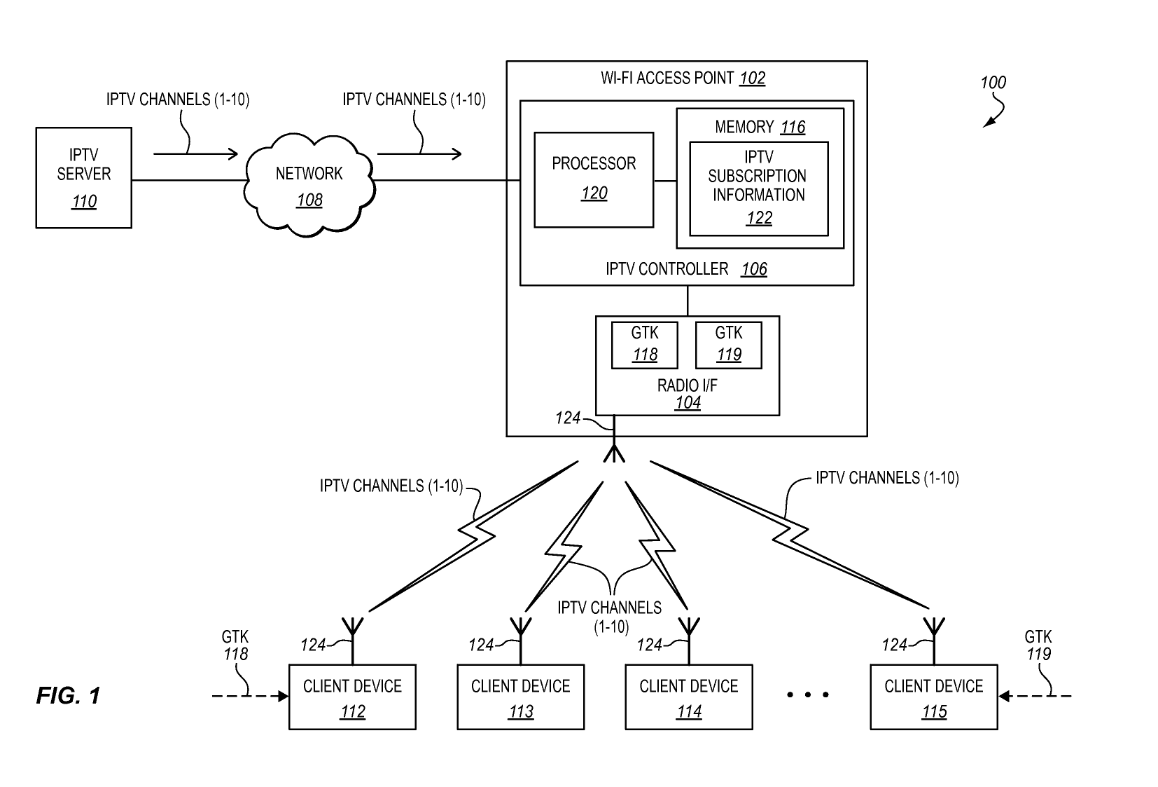

FIG. 1 illustrates a communication network 100 for providing IPTV services over Wi-Fi in an exemplary embodiment. In this embodiment, a Wi-Fi Access Point (AP) 102 provides IPTV services to one or more Wi-Fi clients 112-115. Clients 112-115 may include tablet computers, laptop computers, phones, set top boxes, media players with Wi-Fi capability, media players embedded in Blu-Ray players, media players embedded in Digital Versatile Disk (DVD players, media players embedded in game consoles, etc. One assumption for FIG. 1 is that one or more users subscribe to IPTV services, and have account(s) with an IPTV service provider that operates an IPTV server 110. The user(s) are able to access IPTV channels on clients 112-115 utilizing AP 102, which receives one or more IPTV channel streams from IPTV server 110 over network 108. Network 108 may include the Internet, a Local Area Network (LAN), a cable system, or some other type of packet-switched network. AP 102 may communicate with network 108 via wired or wireless interfaces as a matter of design choice.

AP 102 is enhanced in the following embodiments to provide different levels of IPTV services to clients 112-115 using multicast streams that are encrypted with different GTKs. Typical Wi-Fi multicast services are limited to use of a single GTK for multicast streams, which prevents the IPTV provider from implementing different channel packages on the same AP.

For example, a typical Wi-Fi access point serving an apartment complex would be limited to supplying each connected Wi-Fi client with the same IPTV channels because only one GTK is available to encrypt the multicast IPTV channel streams from the AP. This prevents the IPTV service provider from supplying different levels of IPTV service over Wi-Fi multicast.

In this embodiment, AP 102 includes an IPTV controller 106 and a radio interface (I/F) 104. IPTV controller 106 comprises any component or device that is able to implement IPTV services to clients 112-115. IPTV controller 106 may include one or more processors 120 (e.g., Cortex A9, Intel Atom, etc.), memory 116 (e.g., Flash, Random Access Memory (RAM), etc.), or other components as a matter of design choice in order to implement the functionality described herein for IPTV controller 106. Radio I/F 104 comprises any component or device that is able to communicate wirelessly (e.g., via antenna 124) with clients 112-115, and to encrypt a plurality of multicast streams using different GTKs. In this embodiment, Radio I/F 104 may operate in any Wi-Fi frequency band as a matter of design choice (e.g., 2.4 GHz, 3.6 GHz, 4.9 GHz, 5 GHz, etc.). The particular radio I/F 104 implementation may be country-specific and beyond the scope of this discussion.

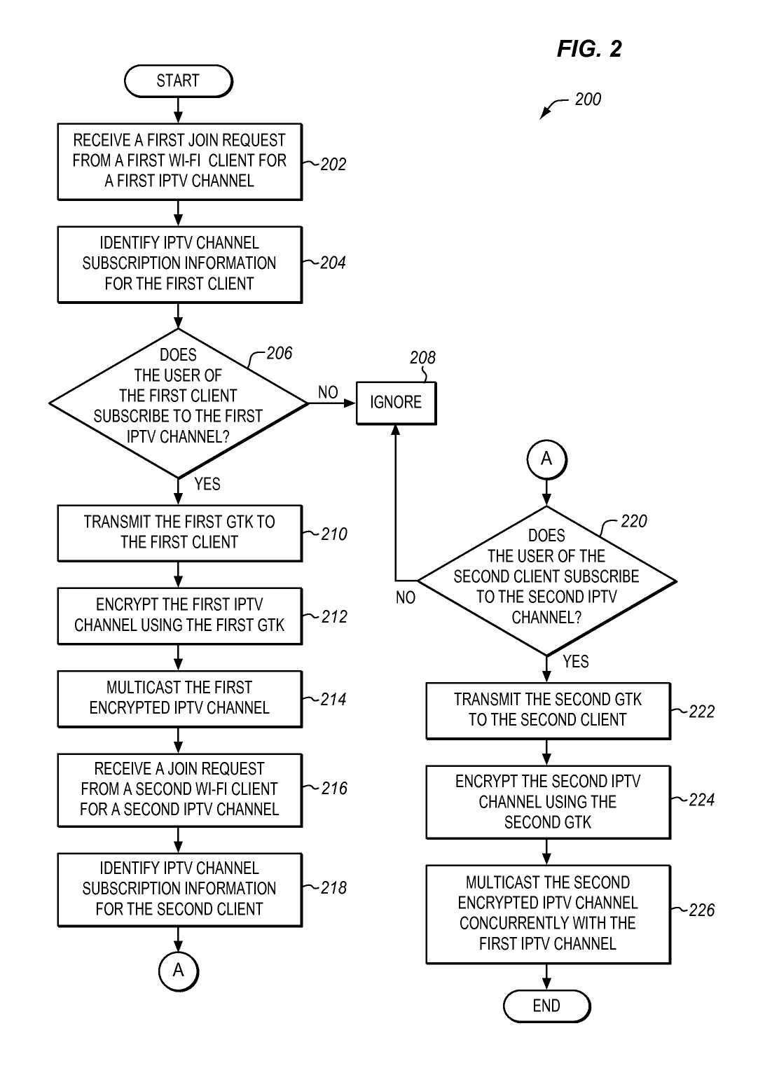

Consider that one or more users of clients 112-115 subscribe to IPTV services. IPTV controller 106 may download subscription information 122 for users of connected client devices 112-115 from IPTV server 110 and store subscription information 122 in memory 116. Consider that a user of client 112 has an IPTV subscription agreement with an IPTV service provider operating IPTV server 110. Also consider that a user of client 115 has an IPTV subscription agreement. For the following discussion, we will assume that clients 112-115 are already authenticated and connected to AP 102. FIG. 2 is a flow chart illustrating a method 200 of providing different levels of IPTV services on Wi-Fi networks utilizing concurrent multicast streams in an exemplary embodiment.

The steps of method 200 will be described with reference to AP 102 of FIG. 1, but those skilled in the art will appreciate that method 200 may be performed in other systems. Also, the steps of the flow charts described herein are not all inclusive and may include other steps not shown, and the steps may be performed in an alternative order.

A user of one of clients 112-115 (e.g., client 112) may log into an IPTV application executing on client 112 to verify the user's IPTV subscription. Client 112 may then be able to display a list of IPTV channels to the user that are part of the user's subscription package. The user may then select an IPTV channel to watch on client 112. Client 112 transmits a join request (e.g., an Internet Group Management Protocol (IGMP) join request) for the IPTV channel to AP 102. Consider for this embodiment that the user selected IPTV channel one (IPTV-1). Radio I/F 104 of AP 102 receives the join request from client 112 (see step 202 of FIG. 2) and forwards the joint request to IPTV controller 106 for processing. IPTV controller 106 may then identify IPTV channel subscription information 122 for the user of client 112 (see step 204 of FIG. 2) and determine if the user of client 112 subscribes to the requested IPTV channel (see step 206 of FIG. 2). To do so, IPTV controller 106 may review IPTV subscription information 122 to identify which IPTV channels the user of client 112 may watch (e.g., based on login information provided by the user of client 112. If the user of client 112 does not subscribe to IPTV-1, then IPTV controller 106 may simply ignore the join request from client device 112 (see step 208 of FIG. 2). However, if the user of client 112 does subscribe to the requested IPTV channel, then IPTV controller 106 may notify radio I/F 104 of this. IPTV controller 106 may then determine whether or not AP 102 is currently receiving IPTV-1 from IPTV server 110. AP 102 may be already receiving IPTV-1 if other clients 113-115 connected to AP 102 are currently receiving IPTV-1. If AP 102 is not receiving a stream for the channel from IPTV server 110, then IPTV controller 106 may transmit an IGMP join request to IPTV server 110 to begin receiving the IPTV stream for IPTV-1.

Radio I/F 104 transmits a Group Temporal Key (GTK) 118 for encrypting IPTV-1 to client device 112 (see step 210 of FIG. 2). As used herein, GTKs refer to transient group keys described in 802.11 which are used to encrypt broadcast/multicast medium access control protocol data units (MPDUs) from a source (e.g., AP 102). GTKs are typically generated from a Group Master Key (GMK) by a broadcast/multicast source. GTKs are not used during the initial authentication of clients 112-115 by AP 102, but rather, are separate group keys specifically used during broadcast/multicast transmissions to clients 112-115. A GTK for a client is encrypted using the Pairwise Transient Key (PTK) created for secure communication between AP 102 and a client (e.g., client 112).

In response to receiving GTK 118, client 112 installs GTK 118 for use in decrypting multicasts from AP 102 that use GTK 118 for encryption. To securely provide GTK 118 to client 112, radio I/F 104 encrypts GTK 118 with the PTK currently in use for encrypting data between AP 102 and client 112.

Using GTK 118, Radio I/F 104 encrypts IPTV-1 requested by the user of client 112 (see step 212 of FIG. 2), and begins multicasting the encrypted IPTV-1 (see step 214 of FIG. 2). Any clients 112-115 with access to the multicast group address can receive the encrypted IPTV-1 from AP 102, but only clients that hold the correct GTK 118 can decrypt IPTV-1. In this embodiment, client 112 holds the correct GTK 118 to decrypt IPTV-1. This allows the user of client 112 to watch the previously selected IPTV-1, and prevents the remaining clients 113-115 from viewing IPTV-1 unless Radio I/F 104 specifically provides GTK 118 to the remaining clients 113-115. Because GTKs are transient keys, Radio I/F 104 may periodically update the appropriate clients 112-115 (e.g., client 112 in this case) with a new GTK, and then begin encrypting IPTV-1 with the new GTK.

Radio I/F 104 may then receive a join request (e.g., IGMP join request, see step 216 of FIG. 2) from one of clients 112-115 (e.g., client 115) for an IPTV channel (e.g., IPTV channel 2 (IPTV-2)). Radio I/F 104 of AP 102 may then forward the joint request to IPTV controller 106 for processing. IPTV controller 106 may then identify IPTV channel subscription information 122 for the user of client 115 (see step 218 of FIG. 2) and determine if the user of client 115 subscribes to the requested IPTV channel (see step 220 of FIG. 2). To do so, IPTV controller 106 may review IPTV subscription information 122 to identify which IPTV channels the user of client 115 may watch (e.g., based on login information provided by the user of client 115). If the user of client 115 does not subscribe to IPTV-2, then IPTV controller 106 may simply ignore the join request from client device 115 (see step 208 of FIG. 2). However, if the user of client 115 does subscribe to the requested IPTV channel, then IPTV controller 106 may notify radio I/F 104 of this. IPTV controller 106 may then determine whether or not AP 102 is currently receiving IPTV-2 from IPTV server 110. AP 102 may be already receiving IPTV-2 if other clients 112-114 connected to AP 102 are currently receiving IPTV-2. If AP 102 is not receiving a stream for the channel from IPTV server 110, then IPTV controller 106 may transmit an IGMP join request to IPTV server 110 to begin receiving the IPTV stream for IPTV-2.

Radio I/F 104 transmits a Group Temporal Key (GTK) 119 for encrypting IPTV-2 to client device 115 (see step 222 of FIG. 2). In response to receiving GTK 119, client 115 installs GTK 119 for use in decrypting multicasts from AP 102 that use GTK 119 for encryption. To securely provide GTK 119 to client 115, radio I/F 104 encrypts GTK 119 with the PTK currently in use for encrypting data between AP 102 and client 115.

Using GTK 119, Radio I/F 104 encrypts IPTV-2 requested by client 115 (see step 224 of FIG. 2), and begins multicasting the encrypted IPTV-2 concurrently with the encrypted IPTV-1 (see step 226 of FIG. 2). Any clients 112-115 with access to the multicast group address can receive the encrypted IPTV-2 from AP 102, but only clients that hold the correct GTK 119 can decrypt IPTV-2. In this embodiment, client 115 holds the correct GTK 119 to decrypt IPTV-2. This allows the user of client 115 to watch the previously selected IPTV-2, and prevents the remaining clients 113-115 from viewing IPTV-2 unless Radio I/F 104 specifically provides GTK 119 to the remaining clients 112-114. Because GTKs are transient keys, Radio I/F 104 may periodically update the appropriate clients 112-115 (e.g., client 115 in this case) with a new GTK, and then begin encrypting IPTV-2 with the new GTK.

Although this particular embodiment describes the use of two GTKs, any number of GTKs could be used by radio I/F 104 when providing IPTV channels to clients 112-115. For instance, a user of client 112 may elect to join a different IPTV channel, which would trigger radio I/F 104 to generate new GTKs, possibly trigger IPTV controller 106 to transmit new IGMP join requests to IPTV server 110, and cause radio I/F 104 to begin multicasting new IPTV channels at AP 102. There is no particular limitation as to the number of concurrent multicast IPTV channels that could be provided by AP 102 to one or more clients 112-115. Further, multiple IPTV channels may be encrypted with the same GTK. For instance, all of the IPTV channels in a particular subscription package may be encrypted with the same GTK, which allows AP 102 to provide one GTK to a particular client 112-115 to allow a user of that client 112-115 to watch any of the IPTV channels in that package. A different subscription package may then be encrypted with a different GTK, which allows AP 102 to segregate clients 112-115 on a package by package basis with regard to which IPTV channels a user is allowed to watch. This allows IPTV providers to more accurately and efficiently provide the user's IPTV subscription service within a Wi-Fi environment.

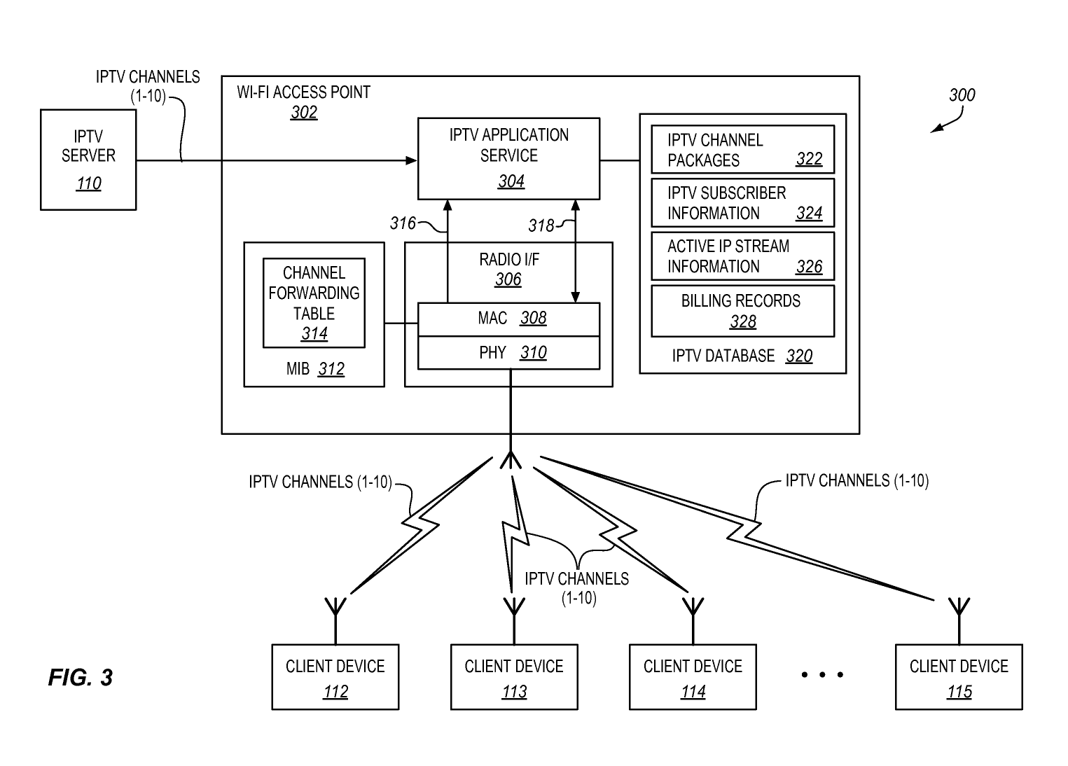

FIG. 3 illustrates another communication network 300 for providing IPTV services over Wi-Fi in an exemplary embodiment. In this embodiment, network 300 includes Wi-Fi Access Point (AP) 302 and a number of Wi-Fi clients 112-115. AP 302 executes an IPTV application service 304, which may operate similar to IPTV controller 106 of FIG. 1. One or more processors (not shown) may execute instructions to run IPTV service 304 on AP 302. In this embodiment AP 302 also includes radio I/F 306, which may operate similar to radio I/F 104 of FIG. 1, and an IPTV database 320. IPTV database 320 stores IP channel packages 322, IPTV subscriber information 324, active IP stream information 326, and billing records 328. IPTV channel packages 322 stores information relating to IPTV channels and how the IPTV channels are bundled into packages for subscribers. IPTV subscriber information 324 stores information relating to current IPTV subscribers that are authorized to access IPTV channels. Active IP stream information 326 relates to which, if any, IPTV channels are currently being streamed by AP 302, and which, if any, clients 112-115 are watching a particular IPTV channel. Billing records 328 stores billing records for IPTV subscribers.

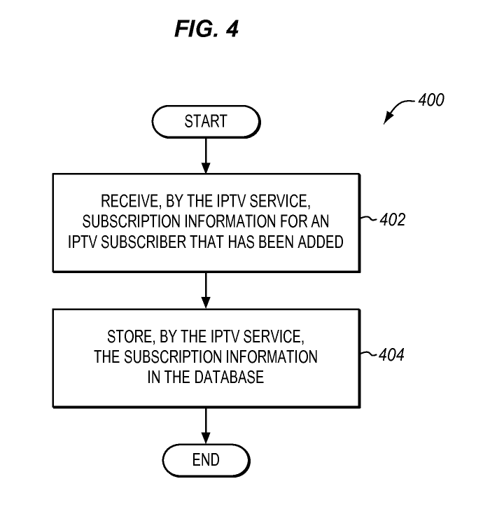

In this embodiment, radio I/F 306 includes a Media Access Control (MAC) layer 308 and a Physical (PHY) layer 310. MAC 308 is coupled to a Management Information Base (MIB) 312, which stores a channel forwarding table 314. Channel forwarding table 314 include IPTV channels that are currently being multicast from AP 302, the GTK associated with each multicast(s), and ID's of clients 112-115 that are joined/watching each of the multicasts. For the following discussion, we will assume that clients 112-115 are already authenticated and connected to AP 302. FIGS. 4-8 illustrate various methods of providing IPTV services to clients 112-115 in a number of exemplary embodiments. The steps illustrated in FIGS. 4-8 will be described with reference to FIG. 3, but those skilled in the art will appreciate that the steps may be performed by other systems, not shown.

Consider the following example. A new user wishes to subscribe to IPTV services offered by an IPTV service provider operating IPTV server 110. The user may log onto a website operated by the IPTV service provider to provide credit card information, address information, etc., that can be used for billing purposes. The user may then select one or more channel packages that are being offered by the IPTV service provider. Upon registering as a new IPTV service user, IPTV server 110 updates Wi-FI access points with this new user information. This allows the new user to access the IPTV services offered by the IPTV service provider over Wi-Fi. FIG. 4 is a flow chart illustrating a method 400 of adding an IPTV subscriber in an exemplary embodiment. IPTV application service 304 receives the subscription information for this new user from IPTV server 110 (see step 402 of FIG. 4), and stores the new user information in IPTV database 320 as a new record within IPTV subscriber information 324 (see step 404 of FIG. 4).

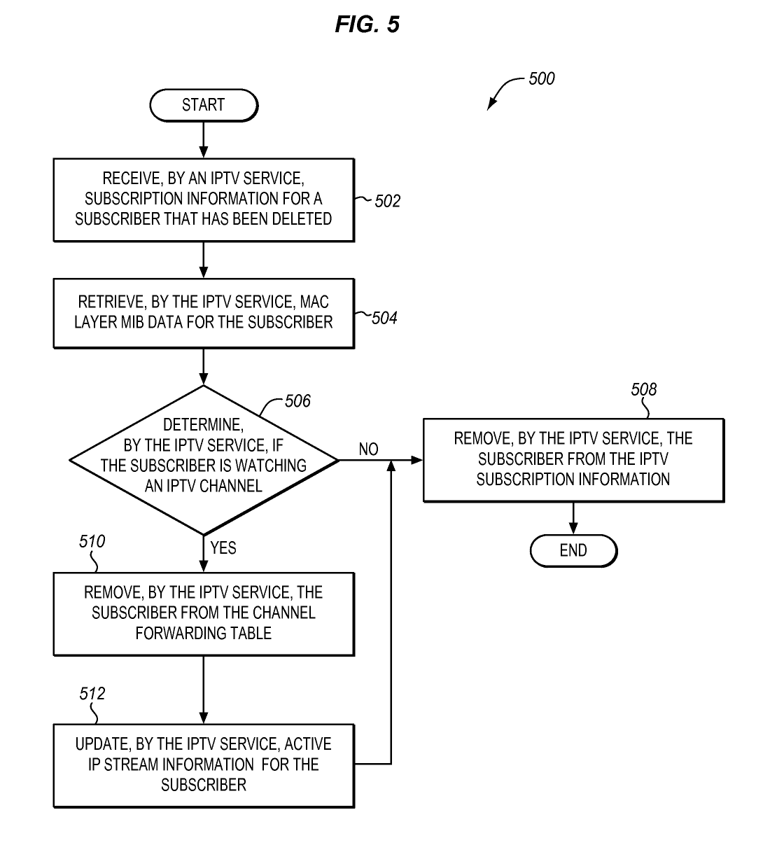

In the next example, a user may wish to remove an active IPTV subscription with an IPTV service provider. The user may log onto the website operated by the IPTV service provider and elect to discontinue his/her IPTV subscription. Upon removing the user as an active IPTV subscriber, IPTV server 110 updates Wi-Fi access points with the change in status for the user. This ensures that the user no longer has access to IPTV services offered by the service provider over Wi-Fi. FIG. 5 is a flow chart illustrating a method 500 of deleting an IPTV subscriber in an exemplary embodiment. IPTV application service 304 receives information from IPTV server 110 regarding a user that has been deleted (see step 502 of FIG. 5). IPTV application service 304 then utilizes a get/set interface 318 between IPTV application service 304 and MAC 308 (see FIG. 3) to retrieve information regarding the user from MIB 312 (see step 504 of FIG. 5). For example, channel forwarding table 314 may indicate whether or not one of clients 112-115 associated with the user is currently joined to a multicast of the IPTV channel. Utilizing the information recovered by the get/set interface 318, IPTV application service 304 determines whether or not the user is currently watching an IPTV channel (see step 506). If the user is currently watching an IPTV channel, the IPTV application service 304 utilizes get/set interface 308 to remove the user from channel forwarding table 314 (see step 510). IPTV application service 304 may then update active IP stream information 326 to indicate that the user is no longer watching the IPTV channel. Radio I/F 306 may then generate a GTK update for the IPTV channel, which is provided to any remaining clients 112-115 that are receiving the IPTV channel. If the user is not currently watching an IPTV channel, then IPTV application service 304 removes the user from IPTV subscriber information 324 (see step 508).

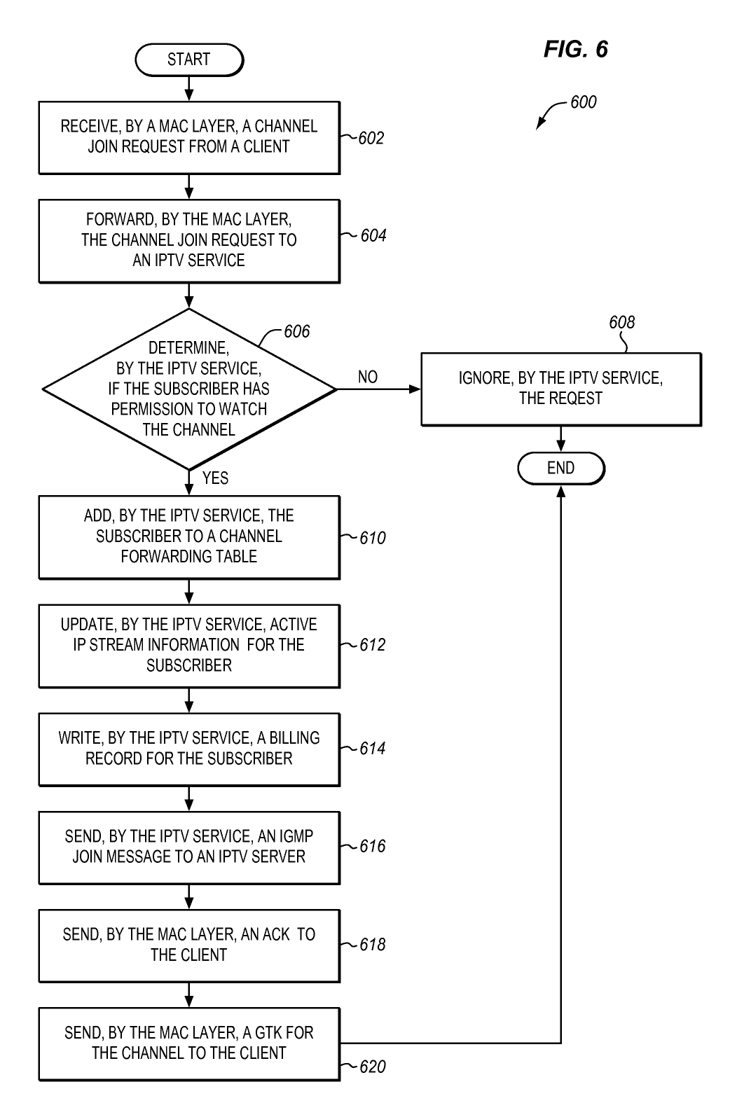

In the next example, a user wishes to join or watch an IPTV channel provided by AP 302. The user may, for instance, utilize a client (e.g., client 112) to log into an IPTV application, and select an IPTV channel to watch (e.g., IPTV-1). Client 112 may then generate an IGMP join request for IPTV-1 and transmit the join request to AP 302. FIG. 6 is a flow chart illustrating a method 600 of adding an IPTV subscriber to an IPTV channel in an exemplary embodiment. MAC 308 receives the join request from client 112 (see step 602 of FIG. 6), and forwards the join request for IPTV-1 to IPTV application service 304 (see step 604 of FIG. 6). To do so, MAC 308 may utilize a notification interface 316 that exists between MAC 308 and IPTV application service 304. IPTV application service 304 determines whether or not the user has permission to watch IPTV-1 (see step 606 of FIG. 6). To do so, IPTV application service 304 may review IPTV subscriber information 324 for the user to determine a particular channel package that the user subscribes to. IPTV application service 304 may then review IPTV channel packages 222 to determine if IPTV-1 is included in the IPTV channel package that the user subscribes to. If the user does not subscribe to the requested IPTV channel (e.g., IPTV-1), then IPTV application service 304 ignores the request (see step 608).

However, if IPTV application service 304 determines that the user does have permission to watch IPTV-1, then IPTV application service 304 adds the user to channel forwarding table 314 (see step 610 of FIG. 6). To do so, IPTV application service 304 utilizes get/set interface 318 to communicate with MAC 308 of radio I/F 306 and add the client ID associated with the user to channel forwarding table 314. IPTV application service 304 may then update active IP stream information 326 to indicate that the user is currently watching IPTV-1 (see step 612 of FIG. 6). IPTV application service 304 may then write a billing record 328 for the user in IPTV database 320 (see step 614 of FIG. 6). Billing record 328 may be periodically provided to IPTV server 110 to allow the IPTV service provider to bill the user for IPTV services. If AP 302 is not currently receiving IPTV-1, then IPTV application service 304 sends an IGMP join message for IPTV-1 to IPTV server 110 (see step 616 of FIG. 6). To determine if AP 302 is currently receiving IPTV-1, IPTV application service 304 may analyze active IP stream information 326 to determine if IPTV-1 is currently being streamed by AP 302. Responsive to the join message, IPTV server 110 adds AP 302 to IPTV-1 multicasts, which is received by AP 302. MAC 308 will then send and ACK message to client 112 for the join request (see step 618), and provide the correct GTK to client 112 to allow the user to watch the requested IPTV channel (see step 620).

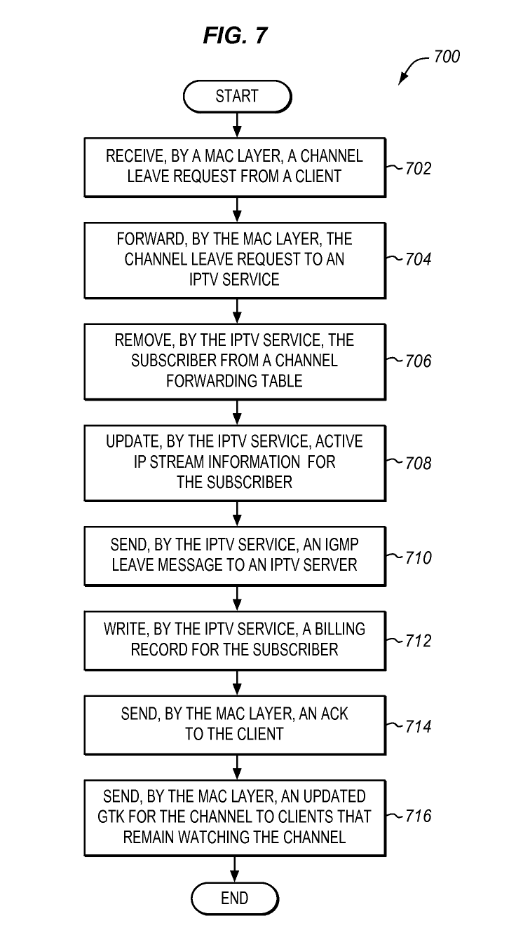

In the next example, consider that the user no longer wishes to receive the IPTV channel. The user may, for instance, utilize a client (e.g., client 112) and the IPTV application to select an IPTV channel to stop watching (e.g., IPTV-1). FIG. 7 is a flow chart illustrating a method 700 of removing an IPTV subscriber from an IPTV channel in an exemplary embodiment. Client 112 may then generate an IGMP leave request for IPTV-1 and transmit the leave request to AP 302. MAC 308 receives the IGMP leave request from client 112 (see step 702 of FIG. 7), and forwards the IGMP leave request to IPTV application service 304 (see step 704 of FIG. 7). To do so, MAC 308 may utilize notification interface 316 that exists between MAC 308 and IP application service 304. IPTV service 304 may then remove the user from channel forwarding table 314 (see step 706 of FIG. 7). To do so, IPTV application service 304 utilizes get/set interface 318 to communicate with MAC 308 of radio I/F 306 and remove the client ID (e.g., an ID for client 112) associated with the user from channel forwarding table 314. IPTV application service 304 updates active IP stream information 326 for the subscriber indicating that the user is no longer watching IPTV-1 (see step 708). If no clients 112-115 remain that receive IPTV-1, then IPTV application service 304 sends an IGMP leave message to IPTV server 110 (see step 710 of FIG. 7). IPTV server 110 removes AP 302 from the stream for IPTV-1. IPTV application service 304 may then write a billing record 328 for the user (see step 712 of FIG. 7). MAC 308 sends an ACK to client 112 responsive to the leave request (see step 714 of FIG. 7). If some of clients 112-115 remain watching IPTV-1, then MAC 308 sends an updated GTK for IPTV-1 to clients 112-115 that remain (see step 716).

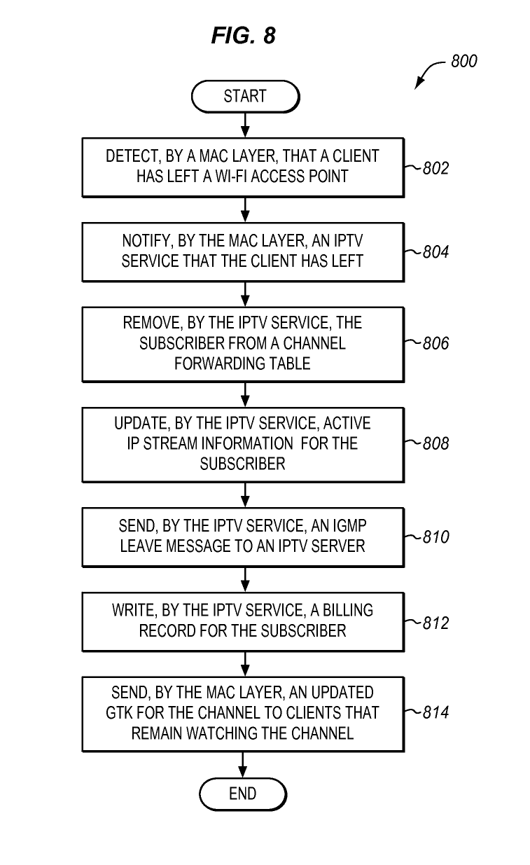

In the next example, consider that a client (e.g., client 112) that was watching an IPTV channel (e. g. IPTV-1) leaves AP 302. In other words, client 112 did not transmit an IGMP leave request to AP 302, but instead perhaps failed to respond to an IGMP query message. IPTV application service 304 may periodically generate IGMP query messages for clients 112-115 that are currently receiving IPTV channel multicasts. This allows IPTV application service 304 to determine whether any of clients 112-115 are still receiving the multicasts. When a client (e.g., client 112) fails to respond to the IGMP query, this may indicate that client 112 is no longer communicating with AP 302 or receiving IPTV-1. FIG. 8 is a flow chart illustrating another method 800 of removing an IPTV subscriber from an IPTV channel in an exemplary embodiment. MAC 308 detects that client 112 has left AP 302. For example, client 112 may fail to respond to an IGMP query or some other type of communication from AP 302 within a time period (see step 802 of FIG. 8). MAC 308 notifies IPTV application service 304 that client 112 has left (see step 804 of FIG. 8). To do so, MAC 308 may utilize notification interface 316. IPTV service 304 then removes the user from channel forwarding table 314 (see step 806 of FIG. 8). To do so, IPTV application service 304 utilizes get/set interface 318 to communicate with MAC 308 of radio I/F 306 and remove the client ID (e.g., an ID for client 112) associated with the user from channel forwarding table 314. IPTV application service 304 updates active IP stream information 326 to indicate that the user is no longer watching IPTV-1 (see step 808 of FIG. 8). If no clients 112-115 remain that receive IPTV-1, then IPTV application service 304 sends an IGMP leave message to IPTV server 110 (see step 810), which then removes AP 302 from the stream for IPTV-1. IPTV application service 304 may then write a billing record 328 for the user (see step 812 of FIG. 8). If some of clients 112-115 remain that are receiving IPTV-1, then MAC sends an updated GTK for IPTV-1 to clients 112-115 that still receive IPTV-1 (see step 814).

Any of the various elements or modules shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope of the invention is not limited to those specific embodiments. The scope of the invention is defined by the following claims and any equivalents thereof.

We claim:

1. An apparatus comprising:
a Wi-Fi access point comprising:
an Internet Protocol Television (IPTV) controller; and
a radio interface configured to receive a first join request from a first Wi-Fi client device for a first IPTV channel;
the IPTV controller configured to identify IPTV channel subscription information for a user of the first client device responsive to the first join request, and to determine if the user of the first client device subscribes to the first IPTV channel based on the subscription information;
the radio interface further configured to transmit a first Group Temporal Key (GTK) to the first client device responsive to a determination that the user of the first client device subscribes to the first IPTV channel, to encrypt the first IPTV channel utilizing the first GTK, and to multicast the first encrypted IPTV channel;
the radio interface further configured to receive a second join request from a second Wi-Fi client device for a second IPTV channel;
the IPTV controller further configured to identify IPTV channel subscription information for a user of the second client device responsive to the second join request, and to determine if the user of the second client device subscribes to the second IPTV channel based on the subscription information;
the radio interface further configured to transmit a second GTK to the second client device responsive to a determination that the user of the second client device subscribes to the second IPTV channel, to encrypt the second IPTV channel utilizing the second GTK, and to multicast the second encrypted IPTV channel concurrently with the first encrypted IPTV channel.

2. The apparatus of claim 1 wherein:
the IPTV controller is further configured to receive updated IPTV channel subscription information for the user of the first client device, and to determine if the user of the first client device subscribes to the first IPTV channel based on the updated IPTV channel subscription information;
the radio interface, responsive to a determination that the user of the first client device no longer subscribes to the first IPTV channel, is further configured to encrypt the first IPTV channel utilizing a third GTK, and to exclude the first client device from receiving the third GTK.

3. The apparatus of claim 1 wherein:
the IPTV controller is further configured to periodically transmit IGMP query messages to the first client device, and to determine if the first client device responds to the IGMP query messages;
the radio interface, responsive to a determination that the first client device does not respond to the IGMP query messages, is further configured to encrypt the first IPTV channel utilizing a third GTK, and to exclude the first client device from receiving the third GTK.

4. The apparatus of claim 1 wherein:
the IPTV controller is further configured to transmit an Internet Group Management Protocol (IGMP) join request to an IPTV server for the first IPTV channel responsive to receiving the first join request.

5. The apparatus of claim 4 wherein:
the IPTV controller is further configured to determine if the Wi-Fi access point is currently receiving the first IPTV channel from the IPTV server, and to transmit the IGMP join request responsive to a determination that the Wi-Fi access point is not currently receiving the first IPTV channel from the IPTV server.

6. The apparatus of claim 1 wherein:
the radio interface is further configured to receive a leave request from the first client device for the first IPTV channel, to transmit a third GTK to Wi-Fi client devices that remain joined to the multicast of the first encrypted IPTV channel responsive to the leave request, and to encrypt the first IPTV channel utilizing the third GTK.

7. The apparatus of claim 1 wherein:
the IPTV controller is further configured to determine if Wi-Fi client devices remain joined to the multicast of the first encrypted IPTV channel, and to transmit an Internet Group Management Protocol (IGMP) leave request to an IPTV server for the first IPTV channel responsive to a determination that no Wi-Fi client devices remain joined.

8. The apparatus of claim 1 wherein:
the IPTV controller is further configured to generate a billing record for the user of the first client device responsive to the first join request.

9. The apparatus of claim 1 wherein:
the IPTV controller is further configured to determine if the user of the first client device is a subscriber to the first IPTV channel responsive to the first join request, and to ignore the first join request responsive to a determination that the user of the first client device is not a subscriber.

10. A method comprising:
receiving, by a Wi-Fi access point, a first join request from a first Wi-Fi client device for a first IPTV channel;
identifying, by the Wi-Fi access point, IPTV channel subscription information for a user of the first client device responsive to the first join request;
determining, by the Wi-Fi access point, if the user of the first client device subscribes to the first IPTV channel based on the subscription information;
transmitting, by the Wi-Fi access point, a first Group Temporal Key (GTK) to the first client device responsive to a determination that the user of the first client device subscribes to the first IPTV channel;
encrypting, by the Wi-Fi access point, the first IPTV channel utilizing the first GTK;
multicasting, by the Wi-Fi access point, the first encrypted IPTV channel;
receiving, by the Wi-Fi access point, a second join request from a second Wi-Fi client device for a second IPTV channel;
identifying, by the Wi-Fi access point, IPTV channel subscription information for a user of the second client device responsive to the second join request;
determining, by the Wi-Fi access point, if the user of the second client device subscribes to the second IPTV channel based on the subscription information;
transmitting, by the Wi-Fi access point, a second GTK to the second client device responsive to a determination that the user of the second client device subscribes to the second IPTV channel;
encrypting, by the Wi-Fi access point, the second IPTV channel utilizing the second GTK; and
multicasting, by the Wi-Fi access point, the second encrypted IPTV channel concurrently with the first encrypted IPTV channel.

11. The method of claim 10 further comprising:
receiving, by the Wi-Fi access point, updated IPTV channel subscription information for the user of the first client device;
determining, by the Wi-Fi access point, if the user of the first client device subscribes to the first IPTV channel based on the updated IPTV channel subscription information;
encrypting, by the Wi-Fi access point, the first IPTV channel utilizing a third GTK; and
excluding, by the Wi-Fi access point, the first client device from receiving the third GTK responsive to a determination that the user of the first client device no longer subscribes to the first IPTV channel.

12. The method of claim 10 further comprising:
transmitting, by the Wi-Fi access point, periodic Internet Group Management Protocol (IGMP) query messages to the first client device;
determining, by the Wi-Fi access point, if the first client device responds to the IGMP query messages;
encrypting, by the Wi-Fi access point, the first IPTV channel utilizing a third GTK; and
excluding, by the Wi-Fi access point, the first client device from receiving the third GTK responsive to a determination that the first client device does not respond to the IGMP query messages.

13. The method of claim 10 further comprising:
transmitting, by the Wi-Fi access point, an Internet Group Management Protocol (IGMP) join request to an IPTV server for the first IPTV channel responsive to the first join request.

14. The method of claim 13 wherein:
the method further comprises:
determining, by the Wi-Fi access point, if the first IPTV channel is being received from the IPTV server; and
the step of transmitting the IGMP join request further comprises:
transmitting the IGMP join request responsive to a determination that the first IPTV channel is not being received.

15. The method of claim 10 further comprising:
receiving, by the Wi-Fi access point, a leave request from the first client device for the first IPTV channel;
transmitting, by the Wi-Fi access point, the third GTK to Wi-Fi client devices that remain joined to the multicast of the first encrypted IPTV channel responsive to the leave request; and
encrypting, by the Wi-Fi access point, the first IPTV channel utilizing the third GTK.

16. The method of claim 10 further comprising:
determining, by the Wi-Fi access point, if Wi-Fi client devices remain joined to the multicast of the first encrypted IPTV channel; and
transmitting, by the Wi-Fi access point, an Internet Group Management Protocol (IGMP) leave request to an IPTV server for the first IPTV channel responsive to a determination that no Wi-Fi client devices remain joined.

17. The method of claim 10 further comprising:
generating, by the Wi-Fi access point, a billing record for the first client device responsive to the first join request.

18. The method of claim 10 further comprising:
determining, by the Wi-Fi access point, if the user of the first client device is a subscriber to the first IPTV channel responsive to the first join request; and
ignoring, by the Wi-Fi access point, the first join request responsive to a determination that the user of the first client device is not a subscriber.

19. An apparatus comprising:
a Wi-Fi client device comprising:
a radio interface configured to communicate with a Wi-Fi Access Point (AP); and
a controller configured to receive Internet Protocol Television IPTV subscription information from a user, and to receive a selection of a first IPTV channel from the user;
radio interface further configured to transmit the subscription information to the AP, and to transmit a first join request to the AP for a first IPTV channel;
the radio interface further configured to receive a first Group Temporal Key (GTK) from the AP responsive to the first join request, and to receive an encrypted multicast of the first IPTV channel from the AP;
the controller further configured to receive a selection of a second IPTV channel from the user;
the radio interface further configured to transmit a second join request to the AP for the second IPTV channel, to receive a second GTK from the AP responsive to the second join request, and to receive an encrypted multicast of the second IPTV channel from the AP concurrently with the encrypted multicast of the first IPTV channel;
the radio interface further configured to decrypt the first IPTV channel utilizing the first GTK, and to decrypt the second IPTV channel utilizing the second GTK.

20. The apparatus of claim 19 wherein:
the first join request and the second join request comprise Internet Group Management Protocol (IGMP) join requests.
